(19) United States
(12) Patent Application Publication
(10) Pub. No.: US 2006/0065672 A1
(43) Pub. Date: Mar. 30, 2006

(54) Medical gas bottle with peripheral protective shell

(75) Inventors: Laurent Lecourt, Sevres (FR); Joseph Mazoyer, Sainte Foy les Lyon (FR); Franck Virey, Paris (FR)

Correspondence Address: Elwood Haynes, Suite 1800, 2700 Post Oak Blvd., Houston, TX, 77056, US

(73) Assignee: Air Liquide Sante (International)

(21) Appl. No.: 11/241,595

(22) Filed: Sep. 29, 2005

(30) Foreign Application Priority Data
Sep. 29, 2004 (FR) 0452189

(51) Int. Cl. B67D 5/00

(52) U.S. Cl. 222/3

(57) ABSTRACT

Portable gas delivery equipment comprising a gas bottle (1) having a height of less than 50 cm, a gas tap or tap/pressure-regulator (2) mounted on the bottle (1), mechanical protection means (3) placed around the bottle (1) and around the said gas tap or tap/pressure-regulator (2), characterized in that the said protection means (3) comprise at least one external rigid shell (3) formed from at least two sub-parts (3a, 3b, 5) that include catching means (10, 11) for firmly fastening the said sub-parts (3a, 3b, 5) together. One or more additional protective elements (14a, 14b) are provided between the half-shells (3a, 3b) and the tap or tap/pressure-regulator (2) in order to improve the protection of the tap (2). Furthermore, the external rigid shell (3) has an external profile with a neck (12) designed in such a way that it allows the equipment to be manually gripped by a user via this neck (12).

The invention relates to a small medical gas bottle with a gas delivery tap or tap/pressure-regulator, the assembly being protected by a rigid protective shell, which may also be covered with a heat-shrinkable film ensuring a level of hygiene compatible with the notion of a medicament.

At the present time, pressurized gas bottles may or may not be provided with an integrated gas application system.

The bottle, and possibly its integrated gas application system, may be mechanically protected by a protective cap or shroud that protects the upper part of the bottle, that is to say the tap or tap/pressure-regulator for releasing the gas and the various elements that may possibly be associated therewith, such as one or more pressure gauges or the like.

However, it is quickly found that the use of such a protective shroud is limited, since it does not protect the entire body of the bottle, but only its upper part.

In addition, such a cap-type device is not suitable for guaranteeing maximum cleanliness and hygiene of the bottle.

To improve this point, it has been proposed to apply one or more thermoformed films around the cylindrical body or over the top of the bottle. Although the thermoformed film improves the cleanliness and hygiene of the bottle, it does not provide a maximum guarantee, as it never protects the entire bottle and its gas application system.

However, certain disposable devices are designed to follow the shape of the bottle and its gas application system. These devices are changed each time the bottle is filled, but in general they do not perfectly follow the complex contours of the bottle and its gas application device, or else these disposable devices are suitable only for large gas bottles weighing several tens of kilograms and having a size of greater than 60 cm, which are therefore incompatible with use on small bottles, that is to say those less than 50 cm in height.

In this regard, mention may be made of the documents US-A-2004/0020793, U.S. Pat. No. 4,967,923 and JP-A-07269790 which describe large gas bottles, each equipped with a protective shroud that may or may not include a carrying handle, the whole assembly being covered by one or more flexible protective sheaths.

Furthermore, the ergonomics, the aesthetics, the hygiene and above all the grippability and transportability of the pressurized gas bottles are not, or only very rarely, taken into account by the manufacturers of medical gas or other gas bottles.

In this regard, mention may be made of the documents US-A-2003/0047178, U.S. Pat. No. 5,119,844, FR-A-2 716 951, U.S. Pat. No. 5,472,024 and U.S. Pat. No. 4,905,855 which propose protective equipment for bottles that, for the most part, does not allow the bottles thus equipped to be easily transported and the ergonomic and hygiene aspects of which are incompatible with use in the medical field.

Now, it should be appreciated that the aesthetic aspect and the grippability and transportability are very important, or even sometimes of paramount importance, for the person using the product, that is to say the patient, in particular when he is not hospitalized, that is to say when the patient has to move around while being permanently supplied with respiratory gas coming from the bottle thus equipped.

Despite this, at the present time the only known systems for slightly improving the ergonomics of pressurized gas bottles are gripping systems usually associated with the cap or with the protective pressure regulator carried by the gas bottles, as described for example in US-A-2004/0020793.

Moreover, document EP-A-903 162 also proposes to protect a reserve of respirable air with an external shroud formed from two water-impermeable parts, with a connection hose to the outside. However, such equipment is not suitable for medical use, especially for the reasons already mentioned above, since it constitutes simply an emergency reserve of air that can be used in an emergency, for example by the pilot of an aircraft that has crashed into the sea or a similar emergency.

Furthermore, some of the known systems of the prior art have a complex architecture, making it complicated and tricky to mount and dismount the equipment.

Thus, it will be understood that the equipment and systems currently existing are very insufficient and do not meet the expectations of users.

The present invention therefore aims to solve these problems by improving the existing equipment, by proposing equipment for effectively protecting medical gas bottles, taps, tap/pressure-regulators, pressure gauges and/or other elements with which they are equipped from the various knocks and damage that they may suffer, especially should they be dropped, which furthermore guarantees better hygiene and more effective cleanliness of the gas bottle, while offering better ergonomics, lower weight and easier handleability for the use, and making the product more attractive, therefore more compatible with public and/or ambulatory use of the treatment, that is to say when not in a hospital environment, since the equipment of the invention must be able to be used almost continuously by patients.

In addition, the equipment for protecting the bottle must be able to be able to easily placed around the bottle to be protected or, conversely, easily removed during maintenance operations, while still allowing the outlet fitting of the gas tap or tap/pressure-regulator equipping the medical gas bottle to be easily connected to a gas delivery device, such as a demand valve.

The solution of the invention is therefore portable gas delivery equipment comprising a gas bottle having a height of less than 50 cm, a gas tap or tap/pressure-regulator mounted on the bottle, and mechanical protection means placed around the bottle and around the said gas tap or tap/pressure-regulator, the said protection means comprising at least one external rigid shell formed from at least two sub-parts that include catching means for firmly fastening the said sub-parts together.

According to one aspect of the equipment of the invention, the sub-parts comprise two half-shells fastened together, forming a protective shell that covers the entire body of the bottle and at least a portion of the tap or tap/pressure-regulator; and one or more additional protective elements are provided between the half-shells and the tap or tap/pressure-regulator. The fact of providing additional protective elements between the half-shells allows the tap or tap/pressure-regulator, the one or more pressure gauges and/or the other elements with which the bottle is equipped to be effectively protected against knocks and damage that might arise during its use, and especially avoids or minimizes any damage to the gas tap or tap/pressure-regulator should the equipment be dropped.

According to another aspect of the equipment of the invention, the sub-parts comprise two half-shells fastened together, forming a protective shell that covers the entire body of the bottle and at least a portion of the tap or tap/pressure-regulator, a closure cap is fitted onto the two half-shells facing the tap or tap/pressure-regulator, at least one of the said protective half-shells and/or the closure cap includes a port located facing the tap or tap/pressure-regulator so as to allow access to at least one fitting on the said tap or tap/pressure-regulator, and the weight of the assembly is less than 5 kg. This contributes not only to effectively protecting the medical gas bottle and the various items of equipment with which it is equipped from the various knocks and damage that it may suffer, especially should it be dropped, but guarantees and also enhances the level of hygiene and cleanliness of the gas bottle, while having a good ergonomic design for the user, making it easy to incorporate the bottle in its peripheral protection, easy to extract it therefrom and easy to connect it, when in use, to a gas delivery device such as a demand valve.

According to yet another aspect of the equipment of the invention, the external rigid shell has an external profile having a neck designed in such a way that it allows the equipment to be manually gripped by a user via this neck. This neck helps to improve the ergonomics of the equipment of the invention, but most of all it allows easy handling thereof by the user, since this neck is designed in such a way that it permits the equipment to be manually gripped via this neck, that is to say the neck is designed so as to allow a patient to hold the equipment with one hand.

Depending on the case, the equipment of the invention may include one or more of the following features:
when the two sub-parts are fastened together, they form a protective shell that covers the entire body of the bottle and at least one portion of the tap or tap/pressure-regulator;
the sub-parts comprise two-half shells;
the external profile obtained after the two half-shells have been fastened together has a peripheral neck formed in the half-shells, that is to say a region having a diameter less than that of the rest of the protective shell;
the peripheral neck is located approximately in the upper third of the said half-shells;
the body of the bottle is formed from aluminium, an aluminium alloy or a composite;
the half-shells are made of plastic, preferably a fire-retarded polymer, that is to say a fire-resistant polymer, with good mechanical strength;
one or more additional protective elements are provided between the sub-units and the tap or tap/pressure-regulator, these protective elements being preferably shaped so as to follow the contours of all or part of the external surface of the said tap or tap/pressure-regulator;
a closure cap is fitted onto the two half-shells facing the tap or tap/pressure-regulator, the said closure cap and two half-shells thus forming the said sub-parts or sub-units constituting the entire rigid protective shell that protects the bottle and the tap or tap/pressure-regulator;
at least one of the said protective half-shells and/or the closure cap includes a port located facing the tap or tap/pressure-regulator so as to allow access to at least one fitting on the said tap or tap/pressure-regulator;
a gas delivery valve, a system for connection to a ventilator or any other gas delivery system is mounted on the said fitting via the port, such as a nebulization system, and preferably the delivery valve is a demand valve;
its weight is less than 5 kg, preferably less than 3 kg and even more preferably less than 2 kg;
it includes a traceability means, in particular a traceability chip based in a housing provided in one of the half-shells, in the closure cap or in one of the additional protective elements, or a bar code placed on the shell or the closure cap;
a gas delivery valve, a system for connection to a ventilator or any other gas delivery system is mounted on the said fitting via the port, and preferably the delivery valve is a demand valve;
a push-button cooperating with the gas delivery valve allows the patient to increase the gas flow by acting on the said push-button and an orifice for access to the said push-button is provided on one and/or the other of the half-shells;
the two half-shells fit together via catching means carried by or placed on the internal wall and/or the bottom of the said half-shells and/or by the protective elements;
the catching means comprise catching hooks carried by one of the half-shells, which cooperate with complementary means placed on the other half-shell;
the internal reinforcements are provided on the internal peripheral wall and/or on the bottom of the half-shells;
the reinforcements and the half-shells are moulded as a single piece; and
a disposable thermoformed film is placed around the periphery of the external half-shells.

The invention will be more clearly understood from the following description, given with reference to the appended figures.

The invention therefore proposes, as shown diagrammatically in the figures appended hereto, to shroud the assembly, formed by the pressurized gas bottle 1, in particular a medical oxygen bottle or a bottle of an oxygen/helium mixture, and its gas application system 2, that is to say mainly the tap or tap/pressure-regulator mounted on this bottle, with a rigid plastic protective shell 3, 3a, 3b that nevertheless allows the user to have easy access to the application members and elements, especially to one (or more) gas outlet fittings carried by the tap or tap/pressure-regulator 2, which shell also guarantees that the bottle has not been tampered with before the said user uses it for the first time.

This is because the user must be able to have easy access to the gas outlet fitting with which the tap or tap/pressure-regulator 2 mounted on the neck of the bottle is equipped, especially when he desires to fit onto it a demand valve 4 or any other similar gas delivery device, such as a nebulization device.

One of the advantages of the assembly of the invention is that the risk to the user is low, as there is no direct contact between the user and the high-pressure part, since this is located beneath the protective shell, the only area of contact being the outlet of the demand valve 4, which is at low pressure.

The protective shell 3, 3a, 3b of the invention covers the entire bottle 1 and also its pressurized gas application system 2.

In addition, the particular shape of this protective shell 3, 3a, 3b improves the ergonomics, since it follows the contours of the body 1b and of the bottom 1a of the bottle 1, and also those of the gas tap or tap/pressure-regulator 2 provided on the bottle 1.

The present invention is particularly suitable for small gas bottles for medical use, that is to say bottles having a height of between 20 and 40 cm and a weight of at most 5 kg, typically around 1.5 to 2 kg. As an example, the gas bottle may have a (water) capacity of 0.47 litres and the maximum gas pressure in it is at least 200 bar, preferably at least 300 bar.

Furthermore, to minimize the weight of the equipment, it is preferred to choose a bottle made of a light material, in particular aluminium or a composite.

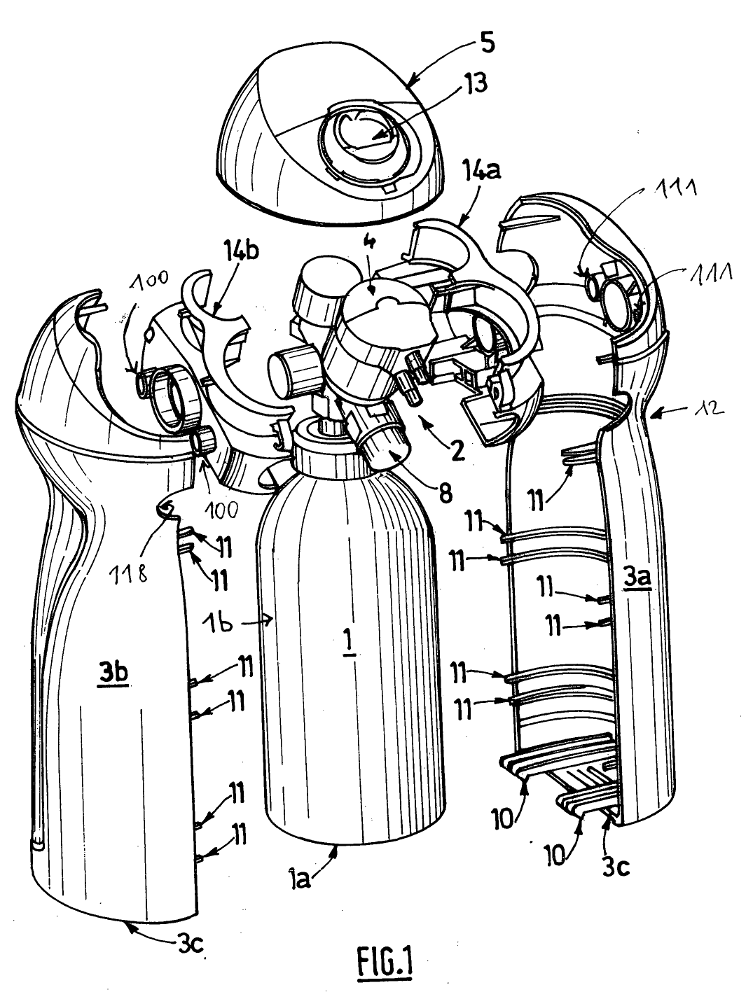

As may be seen in greater detail in FIG. 1, which shows an exploded view of the portable equipment according to the invention, the gas application system 2 and the bottle 1 are protected by a protective shell 3, 3a, 3b formed from two half-shells 3a, 3b on which a closure cap 5 is mounted. However, within the context of the invention, the half-shells 3a, 3b do not necessarily have identical structures, and the protective shell 3 may be formed from more than two sub-structures that are joined together.

To further improve the protection of the tap or tap/pressure-regulator 2 mounted on the bottle 1, as shown in FIG. 1, one or more additional protective elements 14a, 14b are provided between the half-shells 3a, 3b and the tap or tap/pressure-regulator 2, preferably a tap/pressure-regulator 2 optionally provided with a pressure indicator, such as a pressure gauge or the like.

In other words, the additional protective elements 14a, 14b are sandwiched between the internal wall of the half-shells 3a, 3b and the external surface of the tap or tap/pressure-regulator 2, as shown in FIG. 1.

More precisely, the additional protective elements 14a, 14b constitute an additional mechanical protection around the tap or tap/pressure-regulator 2 so as to protect it from the knocks and the like that the external shell 3 might suffer and that are subsequently felt by the tap or tap/pressure-regulator 2 in the absence of such elements 14a, 14b. Preferably, the additional protective elements 14a, 14b are firmly fastened to each other, to form a kind of shield or screen for internally protecting the tap or tap/pressure-regulator 2. For the protection to be more effective, the protective elements 14a, 14b are preferably shaped so as to follow the contours of all or part of the external surface of the said tap or tap/pressure-regulator 2.

The protective elements 14a, 14b are advantageously formed from a material of the plastic type, such as a polymer or the like.

The two half-shells 3a, 3b fit together via catching means 10, 11, 100, 111 that are carried by or placed on the internal wall and/or the bottom 3c of the said half-shells 3a, 3b and/or by the protective elements 14a, 14b that protect the gas application system 2.

The catching means may comprise catching hooks 10 carried by one of the half-shells 3a, 3b, which cooperate with complementary means provided on the other half-shell. Furthermore, so as to make it easier to position and fit the half-shells 3a, 3b together, internal reinforcements 11 are provided on the internal peripheral wall and/or on the bottom 3c of the half-shells 3a, 3b, which reinforcements 11 also help to improve the retention of the bottle 1 inside the shells 3a, 3b by forming stops that prevent any inopportune lateral movements of the bottle 1, for example when the equipment is being transported by the user. Preferably, the reinforcements 11 and/or the catching hooks 10 and the half-shells 3a, 3b are moulded as a single piece.

The half-shells 3a, 3b are fastened to the internal protective elements 14a, 14b by fastening means 100, 111 carried by the half-shells 3a, 3b and the protective elements 14a, 14b, which fastening means cooperate with one another for the purpose of firmly fastening them together, in particular interlocking or similar elements 100, 111. Preferably, these fastening elements 100, 111 and the half-shells 3a, 3b, and also the protective elements 14a, 14b, are moulded as a single piece. Preferably, the fastening elements 100, 111 are carried by and/or are provided in the internal wall of the half-shells 3a, 3b and the external wall of the protective elements 14a, 14b.

The closure cap 5, which covers the upper portion of the bottle 1 and is also fitted onto the half-shells 3a, 3b, ensures that the bottle 1 and its gas application system 2 are completely shrouded and also ensures that the assembly has not been tampered with and that there is continuity of hygiene, since this closure cap 5 in particular prevents the ingress of dust or the like into the upper portion of the bottle 1. More precisely, the tamper-evident guarantee is provided by a tamper-evident cover 13 mounted on the cap 5, this cover having to be removed by the user before the gas is used for the first time. This therefore also makes it possible to distinguish an unused, full bottle, and therefore one with a cover 13, from a bottle that has already been used, that is to say one without a cover.

Furthermore, the external profile obtained after the two half-shells 3a, 3b have been fastened together allows the equipment to be optimally gripped by hand via the neck 12 formed in the half-shells 3a, 3b in approximately the upper third of the said half-shells. Preferably, this neck 12 is designed in such a way that it permits the equipment to be gripped manually via this neck 12, that is to say it is designed to allow a patient to hold the equipment using one hand.

In addition, this neck 12 provides a novel way of making the equipment of the invention aesthetically attractive, particularly when the equipment is designed for use in the health field and more particularly use by patients treated at home.

Advantageously, a disposable thermoformed film is placed around the periphery of the external half-shells, which contributes to guaranteeing maximum cleanliness and hygiene of the equipment and can be used to carry various graphics, labels, legal notices or operating instructions.

Furthermore, a push-button 8 that engages with the valve 4 gives the patient the possibility of increasing the flow of gas received, should he feel the need to do so, for example by acting on this button 8, the patient will receive 1.5 times more oxygen than the fixed setting given by the valve 4. An orifice for access to this push-button 8 is provided on one and/or the other of the half-shells 3a, 3b.

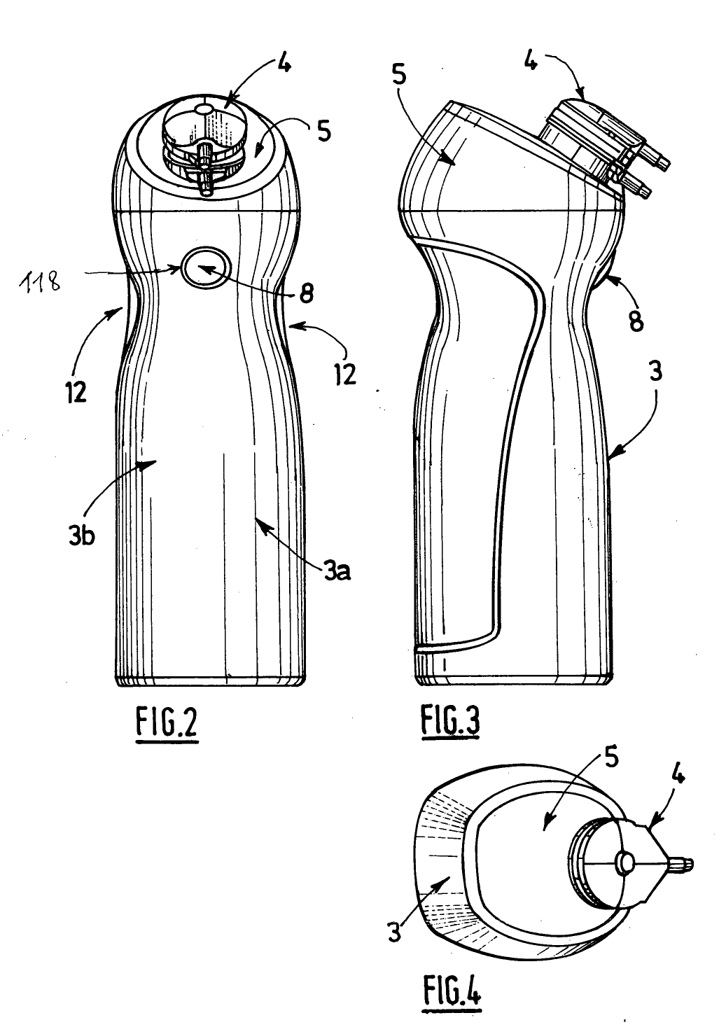

FIGS. 2 and 3 are respectively front and side views of the equipment according to the invention, fitted with a demand valve 4, while FIG. 4 is a top view of the equipment of FIGS. 2 and 3. The references used in FIGS. 2 to 4 denote the same elements as in FIG. 1.

As will have been understood, the means for protecting the assembly of the invention may comprise, depending on the embodiment chosen, an external rigid shell 3, formed in this case from two sub-parts or half-shells 3a, 3b and from a closure cap 5, including catching means for firmly fastening these elements together. However, it is conceivable to produce the equipment differently, namely by having a sub-part 3 formed from a single sleeve (instead of the two half-shells 3a, 3b), this sleeve being made for example of a polymer moulded as a single piece and designed to be able to house the gas bottle, and a second sub-part 5 acting as a closure cap 5, which will sit on top of the single sleeve forming the shell 3 so as to cover and protect the tap or tap/pressure-regulator 2.

Advantageously, the portable gas delivery assembly according to the invention is transported in a suitable carrier bag.

The equipment of the invention is particularly well suited to being filled with medical oxygen or with an oxygen/helium mixture, but it may also be used for filling with other medical gases, such as for example NO/nitrogen mixtures.

1-41. (canceled)

42. A portable gas delivery equipment comprising:
a) a gas bottle (1) having a height of less than 50 cm;
b) a gas tap or tap/pressure-regulator (2) mounted on the bottle (1); and
c) mechanical protection means (3) placed around the bottle (1) and around the said gas tap or tap/pressure-regulator (2), the said protection means (3) comprising at least one external rigid shell (3) formed from at least two sub-parts (3a, 3b, 5) that include catching means (10, 11) for firmly fastening the said sub-parts (3a, 3b, 5) together,
wherein:
a) the sub-parts (3a, 3b, 5) comprise two half-shells (3a, 3b) fastened together, forming a protective shell that covers the entire body of the bottle (1) and at least a portion of the tap or tap/pressure-regulator (2); and
b) one or more additional protective elements (14a, 14b) are provided between the half-shells (3a, 3b) and the tap or tap/pressure-regulator (2).

43. The equipment of claim 42, wherein the protective elements (14a, 14b) are shaped so as to follow the contours of all or part of the external surface of the said tap or tap/pressure-regulator (2).

44. The equipment of claim 42, wherein the half-shells (3a, 3b) are fastened to the internal protective elements (14a, 14b) by fastening means (100, 111) which are on the half-shells (3a, 3b) and on the protective elements (14a, 14b) and which cooperate with one another, and preferably the fastening elements (100, 111) fit into each other so that the said protective elements (14a, 14b) are fastened to the half-shells (3a, 3b).

45. The equipment of claim 42, wherein the fastening elements (100, 111) are on and/or placed in the internal wall of the half-shells (3a, 3b) and the external wall of the protective elements (14a, 14b).

46. The equipment of claim 42, wherein the external profile obtained after the two half-shells (3a, 3b) have been fastened together has a neck (12) formed in the half-shells (3a, 3b), the neck (12) being preferably located approximately in the upper third of the said half-shells (3a, 3b) and designed in such a way that it allows the equipment to be manually gripped via this neck (12).

47. The equipment of claim 43, wherein the weight of the assembly is less than 5 kg.

48. The equipment of claim 42, wherein a gas delivery valve (4), a system for connection to a ventilator or any other gas delivery system is mounted on the said fitting (7) via the port (6), and preferably the delivery valve (4) is a demand valve.

49. The equipment of claim 48, wherein a push-button (8) cooperating with the gas delivery valve (4) allows the patient to increase the gas flow by acting on the said push-button (8) and in that an orifice for access to the said push-button (8) is provided on one and/or the other of the half-shells (3a, 3b).

50. The equipment of claim 42, wherein the body of the bottle (1) is formed from aluminum, an aluminum alloy or a composite.

51. The equipment of claim 42, wherein it includes a traceability means, in particular a traceability chip based in a housing provided in one of the half-shells (3a, 3b), in the closure cap (5) or in one of the additional protective elements (14a, 14b), or a bar code placed on the shell or the closure cap.

52. The equipment of claim 42, wherein the sub-parts (3a, 3b, 5) are made of plastic, preferably a fire-retarded polymer.

53. The equipment of claim 42, wherein the weight of the assembly is less than 3 kg, preferably less than 2 kg.

54. The equipment of claim 42, wherein the two half-shells (3a, 3b) fit together via catching means carried by or placed on the internal wall and/or the bottom (3c) of the said half-shells (3a, 3b) and/or by the protective elements (14a, 14b).

55. The equipment of claim 42, wherein the catching means comprise catching hooks (10) carried by one of the half-shells (3a, 3b), which cooperate with complementary means placed on the other half-shell.

56. The equipment of claim 42, wherein the internal reinforcements (11) are provided on the internal peripheral wall and/or on the bottom (3c) of the half-shells (3a, 3b).

57. The equipment of claim 42, wherein the reinforcements (11) and the half-shells (3a, 3b) are molded as a single piece.

58. The equipment of claim 42, wherein a disposable thermoformed film is placed around the periphery of the external half-shells (3a, 3b).

59. The equipment of claim 42, wherein:
a) a closure cap (5) is fitted onto the two half-shells (3a, 3b) facing the tap or tap/pressure-regulator (2); and
b) at least one of the said protective half-shells and/or the closure cap (5) includes a port (6) located facing the tap or tap/pressure-regulator (2) so as to allow access to at least one fitting (7) on the said tap or tap/pressure-regulator (2).

60. A portable gas delivery equipment comprising:
a) a gas bottle (1) having a height of less than 50 cm;
b) a gas tap or tap/pressure-regulator (2) mounted on the bottle (1); and
c) mechanical protection means (3) placed around the bottle (1) and around the said gas tap or tap/pressure-regulator (2), the said protection means (3) comprising at least one external rigid shell (3) formed from at least two sub-parts (3a, 3b, 5) that include catching means (10, 11) for firmly fastening the said sub-parts (3a, 3b, 5) together,
wherein:
a) the sub-parts (3a, 3b, 5) comprise two half-shells (3a, 3b) fastened together, forming a protective shell that covers the entire body of the bottle (1) and at least a portion of the tap or tap/pressure-regulator (2);
b) a closure cap (5) is fitted onto the two half-shells (3a, 3b) facing the tap or tap/pressure-regulator (2),
c) at least one of the said protective half-shells and/or the closure cap (5) includes a port (6) located facing the tap or tap/pressure-regulator (2) so as to allow access to at least one fitting (7) on the said tap or tap/pressure-regulator regulator (2); and
d) the weight of assembly is less than 5 kg.

61. The equipment of claim 60, wherein the external profile obtained after the two half-shells (3a, 3b) have been fastened together has a neck (12) formed in the half-shells (3a, 3b).

62. The equipment of claim 60, wherein the neck (12) is located approximately in the upper third of the said half-shells (3a, 3b).

63. The equipment of claim 60, wherein the neck (12) is designed in such a way that it allows the equipment to be manually gripped via this neck (12), and preferably the neck (12) is designed to allow the equipment to be held by a patient using one hand.

64. The equipment of claim 60, wherein one or more additional protective elements (14a, 14b) are provided between the half-shells (3a, 3b) and the tap or tap/pressure-regulator (2).

65. The equipment of claim 64, wherein the protective elements (14a, 14b) are shaped so as to follow the contours of all or part of the external surface of the said tap or tap/pressure-regulator (2).

66. The equipment of claim 60, wherein a gas delivery valve (4), a system for connection to a ventilator or any other gas delivery system is mounted on the said fitting (7) via the port (6), and preferably the delivery valve (4) is a demand valve.

67. The equipment of claim 66, wherein a push-button (8) cooperating with the gas delivery valve (4) allows the patient to increase the gas flow by acting on the said push-button (8) and in that an orifice for access to the said push-button (8) is provided on one and/or the other of the half-shells (3a, 3b).

68. The equipment of claim 60, wherein the body of the bottle (1) is formed from aluminum, an aluminum alloy or a composite.

69. The equipment of claim 60, wherein the sub-parts (3a, 3b, 5) are made of a polymer, preferably a fire-retarded polymer.

70. The equipment of claim 60, wherein the weight of the assembly is less than 3 kg, preferably less than 2 kg.

71. The equipment of claim 60, wherein the two half-shells (3a, 3b) fit together via catching means carried by or placed on the internal wall and/or the bottom (3c) of the said half-shells (3a, 3b).

72. The equipment of claim 60, wherein the catching means comprise catching hooks (10) carried by one of the half-shells (3a, 3b), which cooperate with complementary means placed on the other half-shell.

73. The equipment of claim 60, wherein the internal reinforcements (11) are provided on the internal peripheral wall and/or on the bottom (3c) of the half-shells (3a, 3b).

74. The equipment of claim 60, wherein the reinforcements (11) and the half-shells (3a, 3b) are molded as a single piece.

75. A portable gas delivery equipment comprising:
a) a gas bottle (1) having a height of less than 50 cm;
b) a gas tap or tap/pressure-regulator (2) mounted on the bottle (1); and
c) mechanical protection means (3) placed around the bottle (1) and around the said gas tap or tap/pressure-regulator (2), the said protection means (3) comprising at least one external rigid shell (3) formed from at least two sub-parts (3a, 3b, 5) that include catching means (10, 11) for firmly fastening the said sub-parts (3a, 3b, 5) together,
wherein the external rigid shell (3) has an external profile with a neck (12) designed in such a way that it allows the equipment to be manually gripped by a user via this neck (12).

76. The equipment of claim 75, wherein the neck (12) is located approximately in the upper third of the shell.

77. The equipment of claim 75, wherein the neck (12) is designed to allow it to be easily held by a patient using one hand.

78. The equipment of claim 75, wherein the sub-parts (3a, 3b, 5) comprise two half-shells (3a, 3b) fastened together, forming a protective shell that covers the entire body of the bottle (1) and at least a portion of the tap or tap/pressure-regulator (2).

79. The equipment of claim 78, wherein one or more additional protective elements (14a, 14b) are provided between the half-shells (3a, 3b) and the tap or tap/pressure-regulator (2).

80. The equipment of claim 79, wherein the protective elements (14a, 14b) are shaped so as to follow the contours of all or part of the external surface of the said tap or tap/pressure-regulator (2).

81. The equipment of claim 75, wherein:
a) a closure cap (5) is fitted onto the two half-shells (3a, 3b) facing the tap or tap/pressure-regulator (2); and
b) at least one of the said protective half-shells and/or the closure cap (5) includes a port (6) located facing the tap or tap/pressure-regulator (2) so as to allow access to at least one fitting (7) on the said tap or tap/pressure-regulator (2).

82. The equipment of claim 75, wherein the weight of the assembly is less than 5 kg, preferably less than 3 kg.
